(19) United States
(12) Patent Application Publication
(10) Pub. No.: US 2017/0351740 A1
(43) Pub. Date: Dec. 7, 2017

(54) DETERMINING STALWART NODES IN SIGNED SOCIAL NETWORKS

(71) Applicant: International Business Machines Corporation, Armonk, NY (US)

(72) Inventors: Krishnasuri Narayanam, Bangalore (IN); Ramasuri Narayanam, Bangalore (IN); Mukundan Sundararajan, Bangalore (IN)

(21) Appl. No.: 15/175,531

(22) Filed: Jun. 7, 2016

(51) Int. Cl. G06F 17/30; G06Q 50/00

(52) U.S. Cl. CPC G06F 17/30539; G06F 17/30864; G06Q 50/01

(57) ABSTRACT

Determination of the nodes in a signed social network that have the greatest “aggregate assignation value” (or “stalwartness”). The “aggregate assignation value” of a node of a signed social network is a value corresponding to any sort of aggregation of the signs of the connections involving that connection. Some embodiments use a “Greedy algorithm” to determine the most stalwart nodes. Some embodiments of the present invention determine a subset (I₁) of nodes, selected from a social network of nodes, that collectively yield, within a practical timeframe, a maximum stalwartness value, σ(I₁), (within a given tolerance range, and/or within a given confidence interval) compared to the stalwartness values of other subsets of nodes (σ(I₂), σ(I₃), . . . , σ(Iₙ), where n is the number of possible subsets of nodes that can be drawn from the social network) that can be drawn from the social network.

### BACKGROUND

The present invention relates generally to the field of data mining in social networks, and more particularly to providing data about participant nodes in signed social networks.

Social networks, implemented in a distributed manner over a communication network (for example, the internet) have been used for both mining interesting user behavior and knowledge discovery. Some social networks have a very large number of users and a very large number of social network based, and/or non-social-network based, interactions among and/or between the users (see definition of “user,” below). Often the connections among the users in such on-line social media sites exhibit a combination of both positive (including trust, friendship, cooperation) and negative (including distrust, foe, and non-cooperation) interactions.

The interactions, discussed in the previous paragraph, are typically represented as “links” (or “connections” or “edges”) between “nodes” representing users in a social network data set (also called a social network graph). On-line social networks that assign positive and negative links are known as signed “social networks.” Although signed social networks typically assign only positive and negative values to links, it should be understood that a signed social network may (at least in theory) have more than two sign values. An underlying network graph is conventionally based on one measurement criterion among the nodes, such as friendship network, professional network, travel network, etc.

### SUMMARY

According to an aspect of the present invention, there is a method that performs the following operations (not necessarily in the following order): (i) receiving a machine readable signed social network data set that includes data representing a plurality of nodes and a plurality of signed connections among and between the nodes, with each signed connection having an assignation value; (ii) receiving a positive integer value k that is less than a number of total nodes in the plurality of nodes; and (iii) identifying, by machine logic, a set of k most-stalwart node(s) of the plurality of nodes of the social network data set, where the most-stalwart nodes have the largest aggregate assignation values, with an aggregate assignation value for a given node is a numerical value quantifying an aggregate of assignation values of connections involving the given node, and k is a positive integer.

According to a further aspect of the present invention, there is a computer program product comprising a computer readable storage medium having stored thereon: (i) first program instructions programmed to receive a machine readable signed social network data set that includes data representing a plurality of nodes and a plurality of signed connections among and between the nodes, with each signed connection having an assignation value; (ii) second program instructions programmed to receive a positive integer value k that is less than a number of total nodes in the plurality of nodes; and (iii) third program instructions programmed to identify, by machine logic, a set of k most-stalwart node(s) of the plurality of nodes of the social network data set, where the most-stalwart nodes have the largest aggregate assignation values, with an aggregate assignation value for a given node is a numerical value quantifying an aggregate of assignation values of connections involving the given node, and k is a positive integer.

According to a further aspect of the present invention, there is a computer system comprising a processor(s) set, and a computer readable storage medium, wherein the processor(s) set is structured, located, connected and/or programmed to run program instructions stored on the computer readable storage medium, and the program instructions include: (i) first program instructions programmed to receive a machine readable signed social network data set that includes data representing a plurality of nodes and a plurality of signed connections among and between the nodes, with each signed connection having an assignation value; (ii) second program instructions programmed to receive a positive integer value k that is less than a number of total nodes in the plurality of nodes; and (iii) third program instructions programmed to identify, by machine logic, a set of k most-stalwart node(s) of the plurality of nodes of the social network data set, where the most-stalwart nodes have the largest aggregate assignation values, with an aggregate assignation value for a given node is a numerical value quantifying an aggregate of assignation values of connections involving the given node, and k is a positive integer.

According to a further aspect of the present invention, there is a method that performs the following operations (not necessarily in the following order): (i) receiving a machine readable signed social network data set that includes data representing a plurality of nodes and a plurality of signed connections among and between the nodes, with each signed connection having an assignation value; (ii) receiving an integer value k; and (iii) identifying, by machine logic, a set of k least-stalwart node(s) of the plurality of nodes of the social network data set, where the most-stalwart nodes have the lowest aggregate assignation values, with an aggregate assignation value for a given node is a numerical value quantifying an aggregate of assignation values of connections involving the given node.

According to a further aspect of the present invention, there is a computer program product comprising a computer readable storage medium having stored thereon: (i) first program instructions programmed to receive a machine readable signed social network data set that includes data representing a plurality of nodes and a plurality of signed connections among and between the nodes, with each signed connection having an assignation value; (ii) second program instructions programmed to receive an integer value k; and (iii) third program instructions programmed to identify, by machine logic, a set of k least-stalwart node(s) of the plurality of nodes of the social network data set, where the most-stalwart nodes have the lowest aggregate assignation values, with an aggregate assignation value for a given node is a numerical value quantifying an aggregate of assignation values of connections involving the given node.

According to a further aspect of the present invention, there is a computer system comprising a processor(s) set, and a computer readable storage medium, wherein the processor(s) set is structured, located, connected and/or programmed to run program instructions stored on the computer readable storage medium, and the program instructions include: (i) first program instructions programmed to receive a machine readable signed social network data set that includes data representing a plurality of nodes and a plurality of signed connections among and between the nodes, with each signed connection having an assignation value; (ii) second program instructions programmed to receive an integer value k; and (iii) third program instructions programmed to identify, by machine logic, a set of k least-stalwart node(s) of the plurality of nodes of the social network data set, where the most-stalwart nodes have the lowest aggregate assignation values, with an aggregate assignation value for a given node is a numerical value quantifying an aggregate of assignation values of connections involving the given node.

### BRIEF DESCRIPTION OF THE DRAWINGS

FIG. 1 is a block diagram of a first embodiment of a system according to the present invention;

FIG. 2 is a flowchart showing a first embodiment method performed, at least in part, by the first embodiment system;

FIG. 3A is a block diagram showing a machine logic (for example, software) portion of the first embodiment system;

FIG. 3B is a signed directed graph of a social network used by the first embodiment system.

FIG. 4A is a table showing information that is generated by embodiments of the present invention;

FIG. 4B is a graph showing information that is generated by embodiments of the present invention;

FIG. 4C is a graph showing information that is generated by embodiments of the present invention;

FIG. 4D is a graph showing information that is generated by embodiments of the present invention;

FIG. 5 is a directed graph showing information that is helpful in understanding NP-hardness.

### DETAILED DESCRIPTION

Some embodiments of the present invention determine the nodes in a signed social network that have the greatest positive (or greatest negative) “aggregate assignation value” (or “stalwartness”). The “aggregate assignation value” of a node of a signed social network is a value corresponding to any sort of aggregation of the signs of the connections involving that connection. In some embodiments, a positive connection counts as a +1, and a negative connection counts as a −1, and the aggregation is simply the sum of all the +1′ a and −1's. Some embodiments of the present invention are directed to classes of algorithms and/or specific algorithms for quickly determining the most stalwart nodes—which task can be challenging in a large and rapidly changing signed social network.

A social network may have a vast number of nodes, numbering in the hundreds of millions or even billions, and a hugely more vast number of possible subsets of nodes that can be drawn from the network. Some embodiments of the present invention determine a subset (I₁) of nodes, selected from a social network of nodes, that collectively yield, within a practical timeframe, a maximum stalwartness value, σ(I₁), (within a given tolerance range, and/or within a given confidence interval) compared to the stalwartness values of other subsets of nodes (σ(I₂), σ(I₃), . . . , σ(Iₙ), where n is the number of possible subsets of nodes that can be drawn from the social network) that can be drawn from the social network.

This Detailed Description section is divided into the following sub-sections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

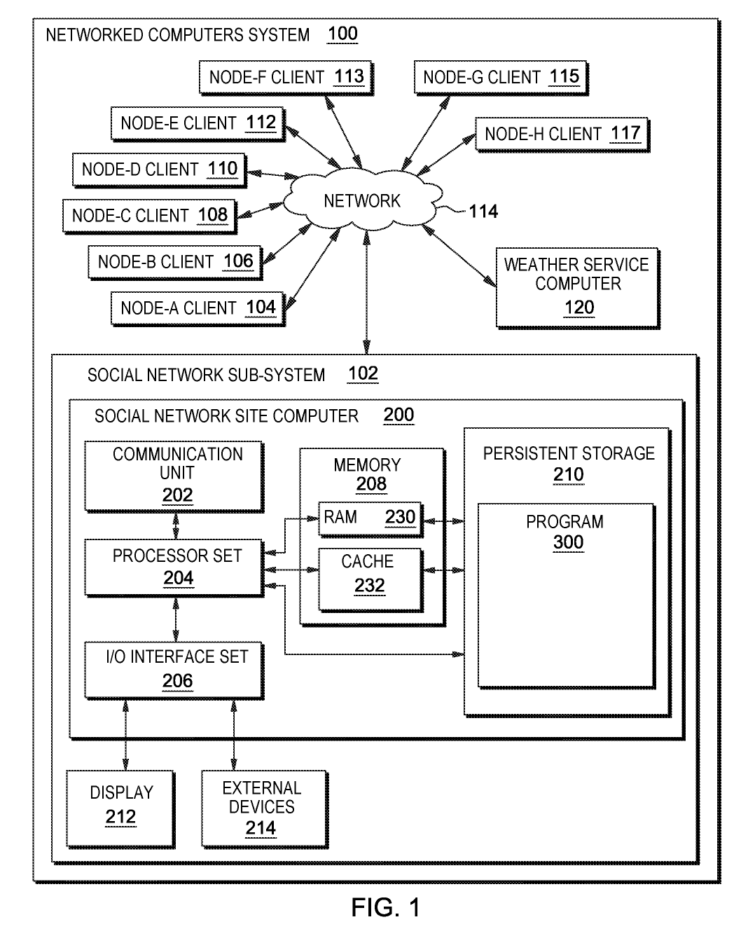

An embodiment of a possible hardware and software environment for software and/or methods according to the present invention will now be described in detail with reference to the Figures. FIG. 1 is a functional block diagram illustrating various portions of networked computers system 100, including: social network sub-system 102; node-A client through node-H client, respectively 104, 106, 108, 110, 112, 113, 115, and 117; communication network 114; weather service computer 120; social network site computer 200; communication unit 202; processor set 204; input/output (I/O) interface set 206; memory device 208; persistent storage device 210; display device 212; external device set 214; random access memory (RAM) devices 230; cache memory device 232; and program 300. In this example: (i) the node-A to node-H clients are devices of participants in a general interest social network site where the participants make postings of various kinds of content to the social network; (ii) social network sub-system 102 is a collection of hardware and software (collectively, machine logic) that manages, controls and administers the social network as a signed social network (the signage rules of this signed social network will be discussed in detail, below, in the Example Embodiment sub-section of this Detailed Description section); and (iii) weather service computer 120 is an example of a third party that uses the “top-k stalwart node data” determined by sub-system 102 (as will be discussed in detail, below, in the Example Embodiment sub-section of this Detailed Description section).

Social network sub-system 102 is, in many respects, representative of the various computer sub-system(s) in the present invention. Accordingly, several portions of social network sub-system 102 will now be discussed in the following paragraphs.

Social network sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage and control certain software functions that will be discussed in detail, below, in the Example Embodiment sub-section of this Detailed Description section.

Social network sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Social network sub-system 102 is shown as a block diagram with many double arrows. These double arrows (no separate reference numerals) represent a communications fabric, which provides communications between various components of social network sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for social network sub-system 102; and/or (ii) devices external to social network sub-system 102 may be able to provide memory for social network sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to social network sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with social network site computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

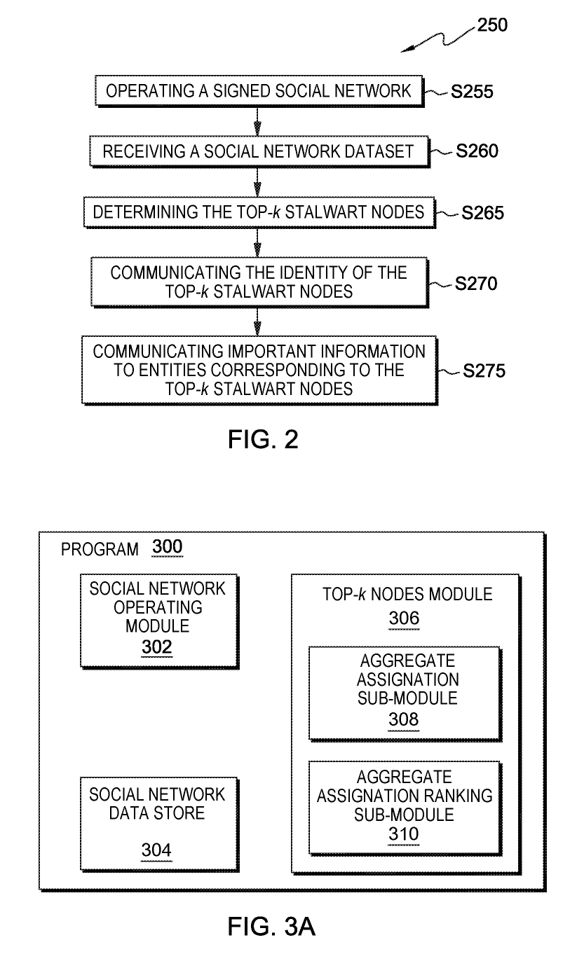

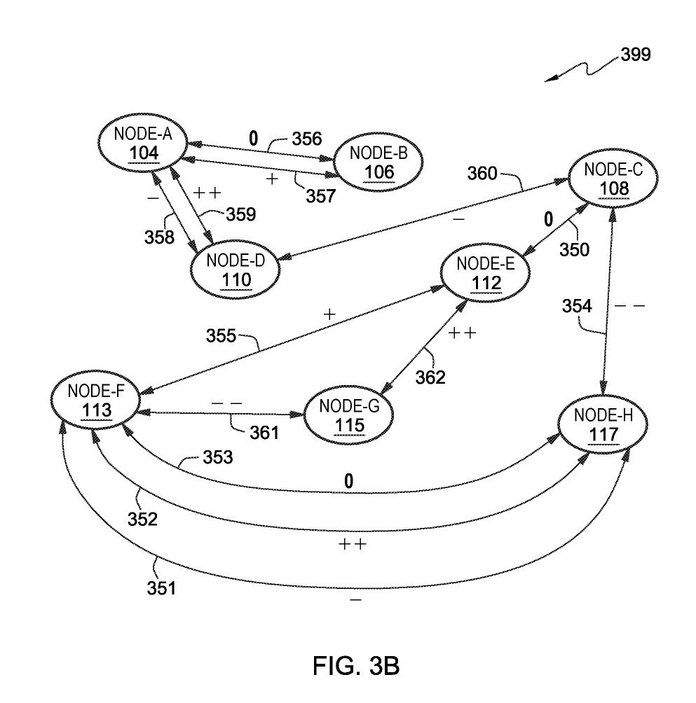

FIG. 2 shows flowchart 250 depicting a method according to the present invention. FIG. 3A shows program 300 for performing at least some of the method operations of flowchart 250. This method and associated software will now be discussed, over the course of the following paragraphs, with extensive reference to FIG. 2 (for the method operation blocks) and FIG. 3A (for the software blocks).

Processing begins at operation 5255, where social network operating module 302 of program 300 operates a signed social network. An example of a signed social network is a general purpose social media website where users sign in, create a user profile, make connections with friends and family, exchange messages, post status updates and comments, share photos and videos, read news items, use various apps, play games, join common-interest user groups, etc. Each user account on the network is a node.

A signed social network can be represented as a graph including: (i) nodes representing the users (see definition, below); and (ii) “signed” connections between the nodes, where: (a) the connection represents some type of interaction between the nodes (which interaction may occur through the social network, or not through the social network), and (b) the sign associated with each connection represents the nature of the connection. These characteristics of a social network will now be further discussed with reference to FIG. 3B.

As shown in FIG. 3B, graph 399 includes nodes 104, 106, 108, 110, 112, 113, 115 and 117; neutral (or “0” connections) 350, 356, 353; single-negative signed connections 351, 358, 360; single-positive signed connections 357, 355; double-negative signed connections 354, 361; and double-positive signed connections 352, 359, 362. In one embodiment, the nodes represent users as follows: (i) node A 104 is a company (specifically a retail store); (ii) node E 112 is a social club; (iii) node H 117 is a family; and (iv) nodes B, C, D, F, G (that is, nodes 106, 108, 110, 113, 117) respectively represent individuals. In this example graph 399, there are not very many nodes, but many embodiments of signed social networks will include thousands, or even millions of nodes. In this example graph 399, all of the nodes are located within the same region, but, in many embodiments, the nodes will be spread over a wide geographic area, and, also, a node (for example, a node representing a large, multi-national corporation) may not be strongly associated with any single geographical location. By comparing FIG. 3B to FIG. 1, it can be seen that the nodes of graph 399 correspond to network-connected communication devices used by the nodes to access the social network operated by social network operating module 302.

In graph 399, the “sign” of a connection represents whether the transactions that gave rise to the connection has positive (for example, happiness, satisfaction, trust, good health, etc.) or negative associations. Alternatively, in other signed social networks, the signs may represent different qualities, other than general emotional positivity and general emotional negativity. For example, a signed social network might: (i) assign connections with urban subject matter as “+”; and (ii) assign connections with rural subject matter as “−”. In graph 399, connections can be assigned as double-positive or double-negative, which, as one may guess, merely means that the connection is more strongly positive or more strongly negative (as the case may be). In graph 399, the signage of a connection is assigned by the users (specifically, in this example, one, or more of the users being connected by the connection). Alternatively, the signage may be assigned by machine logic, such as connection signage analytics. Some specific examples of the connections of graph 399 will be discussed in detail in the following paragraphs.

In graph 399, node B is an individual who is an amateur photographer. She took a picture of the parking lot of the retail store corresponding to node A and posted the image to the social network with the caption: “Here is the parking lot of a local store.” The posting of this photo results in the formation of connection 356, which is a neutral connection. As may be mentioned elsewhere in this document, not all signed social networks allow neutral value connections. With signed social networks that do allow neutral type connections, these connections may, or may not, impact the “aggregate assignation value” of a node. The concept of aggregate assignation value, and some of the various ways (or schemes) of calculating aggregate assignation value, will be further discussed, below.

In graph 399, node B posted another photo, this time of an awning affixed to the retail store of node A, and this time with the caption: “What a nice awning!” This gave rise to single positive connection 357. It is noted that the social network of graph 399 allows multiple connections between two given nodes, such as the two connections 356 and 357 between nodes A and B. Alternatively, some embodiments of signed social networks may aggregate all connections between two nodes into a single signed connection. For example, connections 356 and 357 could be aggregated into a single connection having a signage value of 0, + or half-plus (depending upon the design choice of the designer of the signed social network as embodied in the machine logic controlling operation of the signed social network).

In graph 399, a strongly negative (“−−”) connection 361 is shown between nodes F and G. This connection arose from an interaction where node F “unfriended” node G. Alternatively, strongly negative connections may arise from other types of interactions.

In graph 399, connections between nodes apply bi-directionally. For example the double-plus (“++”) connection 359 between nodes A and D contributes equally to the assignation values for nodes A and D. Alternatively, in some embodiments of the present invention, connections between nodes may be unidirectional, such that the connection signage contributes to the aggregate assignation value of the target node but not to the source node (or vice versa, depending upon design choices made by the network designer as embodied in the machine logic controlling operation of the signed social network). In some embodiments, the bi-directional connections used in graph 399, may be replaced by two unidirectional connections between the two involved nodes, each with its signage. For example, returning to connection 361, the unfriending represented by this connection may be broken into: (i) a double negative unidirectional connection from node F (the unfriending node) to node G (the unfriended node); and (ii) a neutral connection directed from node G (the unfriended node) to node F (the unfriending node). This may allow more accuracy and/or precision in determining connection signage.

In graph 399, a strongly positive (“++”) relationship, represented by, for example, edge 362 between nodes E and G in the graph. The user corresponding to node E contributes money to an organization entity corresponding to node G. However, this contribution of funds was made without involving the social network, for example by mailing a personal check to the charity sent through postal mail. However, the organization of node G posts a thank you to node E (that is, the individual corresponding to node E) on a website for the organization entity. In this example, the social network harvests this publically available information and generates edge 362 and assigns it a “++” signage (because a financial contribution reflects highly positively on both the generosity of node E and also on the regard in which node E apparently holds the organization of node G). The main point of this paragraph is that edges of a signed social network graph do not always necessarily reflect transactions conducted through the social network itself, but may arise from other publically available information sources.

Although not used or shown in graph 399, in some embodiments of the present invention, there are multiple types (or dimensions) of signage with respect to connections between nodes. For example, a first node may post a social networking post that says: “plastic ship hulls are the future of trans-oceanic travel.” A second node may comment on this post as follows: “that is a great idea from a technological perspective, but it will never fly politically.” In this example, the comment leads to a connection from the second node to the first node that: (i) has a positive signage with respect to a technology dimension; and (ii) a negative signage with respect to a political dimension.

Processing proceeds at operation S260 where social network data store 304 of program 300 receives a social network dataset. This basically means that a machine readable version of the information of graph 399 is maintained, on an on-going basis, as the social interactions of the signed social network graph evolve and develop. The social network data set serves as input data for the operations to be discussed, below, where the top-k stalwart nodes of the signed social network are determined.

Processing proceeds to operation S265, where top-k nodes module 306 determines an identity of some number (called k) of nodes of graph 399 that have the greatest “aggregate assignation values” (also sometimes herein referred to as “stalwartness”). In this example, k will be set at 2. Because the present example of the invention is highly simplified for pedagogical purposes, the identification of the top two (2) most-stalwart nodes will be relatively computationally non-intensive. However, in many, if not most, real world applications the total number of nodes in the social network will be huge, which, in those applications, makes the task of finding the top k-nodes a much more challenging process from a computational point of view. On a related note, the particular algorithm used in this pedagogical example, may not be practical for use on a large social network. Rather, the example of FIGS. 2 and 3 is intended to help the reader understand important concepts like “aggregate assignation value,” and to appreciate the myriad variations on basic constructs like “signed connections” (some of these variations are discussed, above, in this sub-section) and “aggregate assignation values” (some of these variations will be discussed, below, in this sub-section). The Further Comments And/or Embodiments sub-section, below, will deal with other, more complex, and perhaps more preferred, algorithms for determining the top-k stalwart nodes. Some of those embodiments may identify the top-k stalwart nodes with less accuracy and/or reliability, than the simple (but comprehensive) method to be discussed, now, in connection with the remaining portion of method 250 shown in FIG. 2. As used herein, phrases such as “identification of the top-k stalwart nodes” are broadly applicable to methods that identify these nodes with perfect accuracy, as well as methods that use approximations to identify the top-k stalwart nodes with less than perfect accuracy.

In the method of flowchart 250, at operation S265, aggregate assignation sub-module 308 determines the “aggregate assignation” for each node of graph 399. Alternatively, and as will be discussed in detail in the following sub-section, in some embodiments, the aggregate assignation value is not calculated for each and every node. However, in this example, the aggregate assignation value is calculated for each and every node.

In this example, the convention for calculating “aggregate assignation value” (see definition in the definitions sub-section, below) is as follows: (i) a neutral connection involving a node adds 0.1 to the aggregate assignation value of that node; (ii) a single positive connection involving a node adds 1.0 to the aggregate assignation value of that node; (iii) a single negative connection involving a node subtracts 0.5 from the aggregate assignation value of that node; (iv) a double positive connection involving a node adds 1.5 to the aggregate assignation value of that node; and (v) a double negative connection involving a node subtracts 1.5 from the aggregate assignation value of that node. Using these machine logic based rules, aggregate assignation sub-module 308 determines the aggregate assignation for each node of graph 399 as follows: (i) node A=+2.1; (ii) node B=+1.1; (iii) node C=−1.9; (iv) node D=+0.5; (v) node E=+2.6; (vi) node F=+0.6; (vii) node G=0.0; and (viii) node H=−0.4. It is noted that aggregate assignation value can be calculated in many, many different ways, so long as the signages of the connections are combined in some meaningful way. Typically, system designers should try to calculate aggregate assignation values in a manner that is most useful with respect to the ways in which the top-k stalwart nodes are intended to be used by the social network (see sub-system 102 of FIG. 1), its participants (see, nodes A to H of FIG. 1) and/or third parties (see, weather service computer 120 of FIG. 1).

In the method of flowchart 250, at operation S265, aggregate assignation ranking 310 sub-module determines a ranking for each node of graph 399 with respect to that nodes aggregate assignation value. Alternatively, some embodiments may only do a partial ranking (for example, a partial ranking of extremely large positive aggregate assignation values, a partial ranking of extremely large negative aggregate assignation values, a partial ranging of extremely large absolute aggregation values).

In this example, the ranking of the nodes (from largest to smallest) is as follows: (i) node E=+2.6; (ii) node A=+2.1; (iii) node B=+1.1; (iv) node F=+0.6; (v) node D=+0.5; (vi) node G=0.0; (vii) node H=−0.4; and (viii) node C=−1.9.

In this example, the top two (2) stalwart nodes (that is, k=2, as stated above) are: (i) nodes E and A for largest positive aggregate assignation value; (ii) nodes C and H for smallest aggregate assignation value; and (iii) nodes E and A for largest absolute aggregate assignation value. Which of these three types of top-k stalwart nodes is the most applicable, or useful, type will depend upon the specific application.

Processing proceeds to operation S270 where top-k stalwart nodes module (“mod”) 306 communicates the identity of the top-k (in this example, k=2) stalwart nodes to storage (for example social network data store 304 of program 300) and/or interested third party(ies). In this example, weather service computer 120 (see FIG. 1) wants to get an important hazardous weather condition update out to the community in a targeted way, without flooding the network with hazard warnings. In this example and for this purpose, mod 306 emails weather service computer the identity of the top-k stalwart nodes with the largest positive values (that is nodes E and A), under the theory that these nodes will have the most credibility, and best judgement, in alerting the community to the approaching hazardous weather condition. As will be appreciated by those of skill in the art, the possible uses for the top-k stalwart nodes are potentially many and various.

Processing proceeds to operation 5275 where people operating the weather service computer alerts nodes E and A by personally telephone calling them at their home and work numbers. Although this form of responsive action is human resource intensive (for both the weather service and for nodes E and A), it has, in this example, been judged the best way of getting this important warning out to the community in a responsible and credible way. Alternatively, many other ways of contacting the top-k stalwart nodes are possible. That said, the idea that the weather service is personally telephone calling people emphasizes the potential importance of providing highly targeting communications to a set of top-k stalwart nodes, which have been accurately identified under this embodiment of the present invention.

### III. Further Comments and/or Embodiments

Some mathematical terminology, helpful in understanding various embodiments of the present invention, will now be developed, starting with terminology relating to signed connections among nodes in a social network graph. Formally, a signed social network can be modeled as a graph G=(V,E) where V is a set of individuals (or autonomous entities) and E is a set of (positive or negative) links among these individuals (or entities).

Moving now to some mathematical expressions applicable to signed social networks, problem formulation, applicable to some embodiments, is presented in the following few paragraphs.

Let (I)⊂V be a subset of vertices in G.

Define T⁺(I)⊂V to be a set of positive incoming links to any node in I. That is,

T⁺(I)={(j,i)|s(j,i)=+1,jεV\I,iεI}.

Similarly, define T⁻(I)⊂V to be a set of negative links to any node in I. That is,

T⁻(I)={(j,i)|s(j,i)=−1,jεV\I,iεI}.

The stalwartness of a set is defined, in this embodiment, as follows: Consider I⊂V. The stalwartness of I, σ(I), is the difference between the number of elements in T⁺(I) and T⁻(I). That is,

σ(I)=|T⁺(I)|−|T⁻(I)|.

The top-k stalwart nodes problem is stated, in this embodiment, as follows: Given a directed graph G=(V,E) and an integer k<|V|, determine a set I⊂V of size k such that the value of σ(I) is maximized.

Problem formulation, applicable in some embodiments of the present invention, is presented in the following few paragraphs.

Define L⁺(I)⊂V to be a set of positive incoming links to any node in I. That is,

L⁺(I)={(j,i)|s(j,i)=+1,jεI,iεI}.

Similarly, L⁻(I)⊂V to be a set of negative incoming links to any node in I. That is,

L⁻(I)={(j,i)|s(j,i)=−1,jεI,iεI}.

The stalwartness of a set is defined, in this embodiment, as follows: Consider I⊂V. The stalwartness of I, σ(I), is the difference between the number of elements in T⁺(I) and T⁻(I) plus the difference between the number of elements in L⁺(I) and L⁻(I). That is,

σ(I)=|T⁺(I)|−|T⁻(I)|+|L⁺(I)|−|L⁻(I)|.

The top-k stalwart nodes problem is stated, in this embodiment, as follows: Given a directed graph G=(V,E) and an integer k<|V|, determine a set I⊂V of size k such that the value of σ(I) is maximized.

Problem formulation, applicable to some embodiments, is presented in the following few paragraphs. In this embodiment, weights of edges of in the social network graph are considered appropriately in defining an objective function.

Let (I)⊂V be a subset of vertices in G and each edge (i,j) has weight w(i,j).

Define W⁺(I)⊂V to be a set of positive incoming links to any node in I. That is,

$${W}^{+} ( I ) = {\sum }_{\{ ( i , j ) \vert w ( i , j ) > 0 , j ∈ V \backslash I , i ∈ I \}} w ( i , j ) .$$

Similarly, define W⁻(I)⊂V to be a set of negative incoming links to any node in I. That is,

$${W}^{-} ( I ) = {\sum }_{\{ ( i , j ) \vert w ( i , j ) < 0 , j ∈ V \backslash I , i ∈ I \}} w ( i , j ) .$$

The stalwartness of a set is defined, in this embodiment, as follows: Consider I⊂V. The stalwartness of I, σ(I), is the difference between the values of W⁺(I) and W⁻(I). That is,

σ(I)=W⁺(I)−W⁻(I).

The top-k stalwart nodes problem is stated, in this embodiment, as follows: Given a directed graph G=(V,E) and an integer k<|V|, determine a set I⊂V of size k such that the value of σ(I) is maximized.

The top-k stalwart nodes problem is computationally hard (difficult), and is a reduction from the well-known Hitting Set problem (also known as the set cover problem), which is an NP-hard problem (see definition in the Definitions sub-section of this Detailed Description section). To handle very large networks, algorithms in some embodiments of the present invention, are designed to be scalable.

Some embodiments of the present invention may include one, or more, of the following features, characteristics and/or advantages: (i) seeding for information spread; (ii) management of city infrastructure; and/or (iii) recommend new links in signed social networks. The next few paragraphs expand upon the items listed in this paragraph.

Seeding for information spread: companies typically rely on viral marketing of their products to maximize revenue. Signed social networks, in some embodiments of the present invention, capture real-life social interactions in manner that is better than un-signed social networks. Some embodiments of the present invention suggest which nodes to target in a social network, to effectively spread information over the network.

Management of city infrastructure: in one embodiment of the present invention, a positive sign is interpreted as a congested road segment between two locations in a city. Conversely, a negative sign is interpreted as a non-congested road segment between two locations in the city. In this embodiment, the top-k stalwart nodes problem helps to determine a set of locations for which the approaching roads are mostly congested. This knowledge is used to improve the organization of the city infrastructure, by suggesting improvements such as construction of flyovers, widening of roads, etc.

Recommending new links: some embodiments of the present invention help to recommend a set of socially well-connected and trusted individual(s) to carry out a certain task or to form friendships (that is, in a link-prediction context).

Some embodiments of the present invention make use of one embodiment of a “Greedy algorithm” for finding top-k stalwart nodes as follows:

Set I₀ ← φ
for i = 1 to k do

Choose a node nᵢ ∈ N\Iᵢ₋₁ that

maximizes σ(Iᵢ₋₁ ∪ {nᵢ}) − σ(Iᵢ₋₁)

Set Iᵢ ← Iᵢ₋₁ ∪ {nᵢ}

end for

### Where:

N is the set of nodes in the signed social network.
Iᵢ₋₁ is a partial solution being identified/constructed by this algorithm at the end of the (i−1)^{th} iteration. Note: to select the top k nodes, the above algorithm selects k nodes in each iteration.
N\Iᵢ₋₁ refers to the set of nodes not selected into the solution set so far (up until iteration (i−1) of the algorithm). The “\” operator is a “set difference” operator, which excludes the elements in Iᵢ₋₁ from the set N.

The above Greedy algorithm approximates the top-k stalwart nodes problem within a ratio of (1−e^{-H}^{ₖ}), where: Hₖ is the k^{th} harmonic number (see definition of harmonic number in the Definitions sub-section of this Detailed Description section) and e is the base of the natural logarithms, approximately equal to 2.7182818.

There are at least two heuristics for solving the top-k stalwart nodes problem in some embodiments of the present invention: (i) maximum degree heuristic, in which for each node, a net-out-degree is defined to be the difference between the number of nodes accessible through positive outgoing links and those through negative outgoing links, then the top-k nodes with high net-out-degree are chosen; and/or (ii) random heuristic, in which k nodes are chosen uniformly at random.

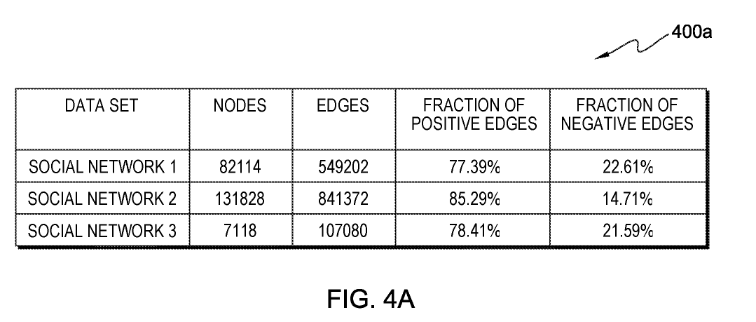

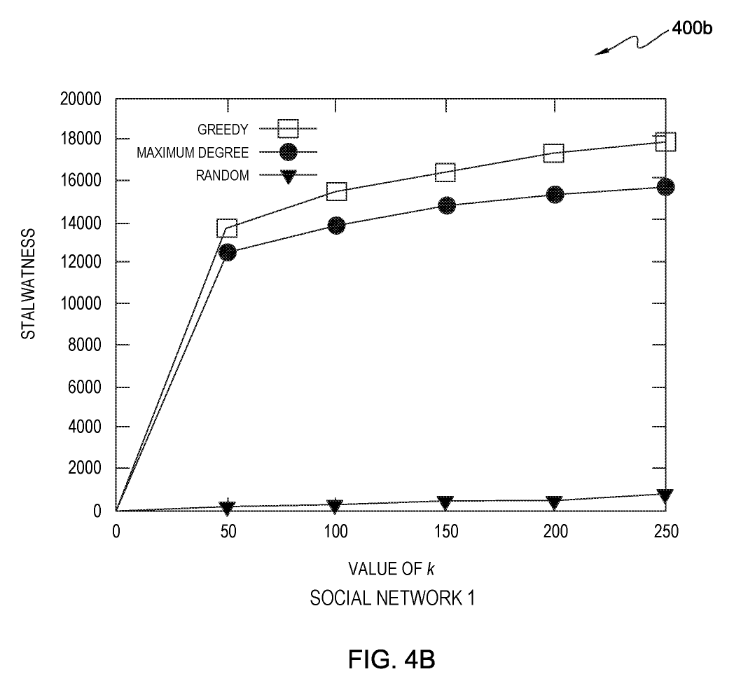

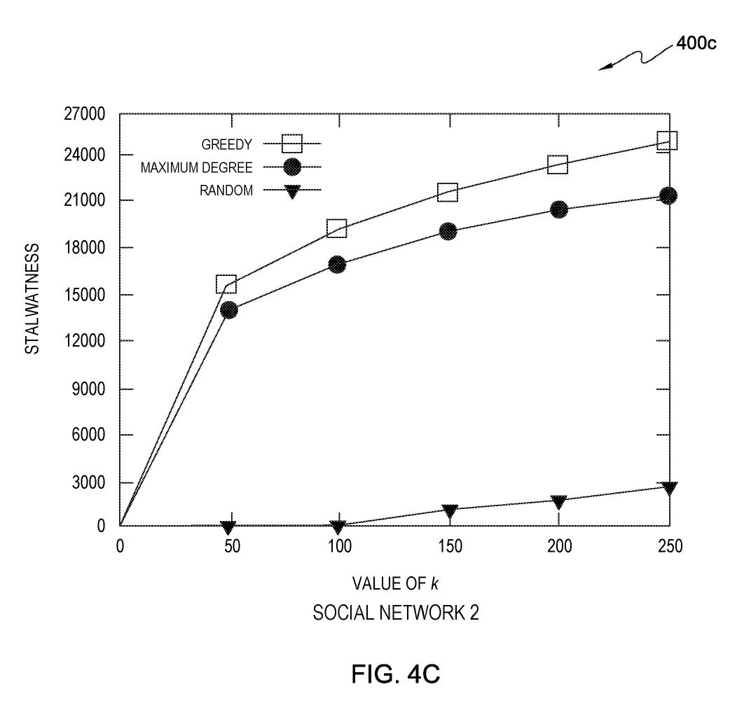

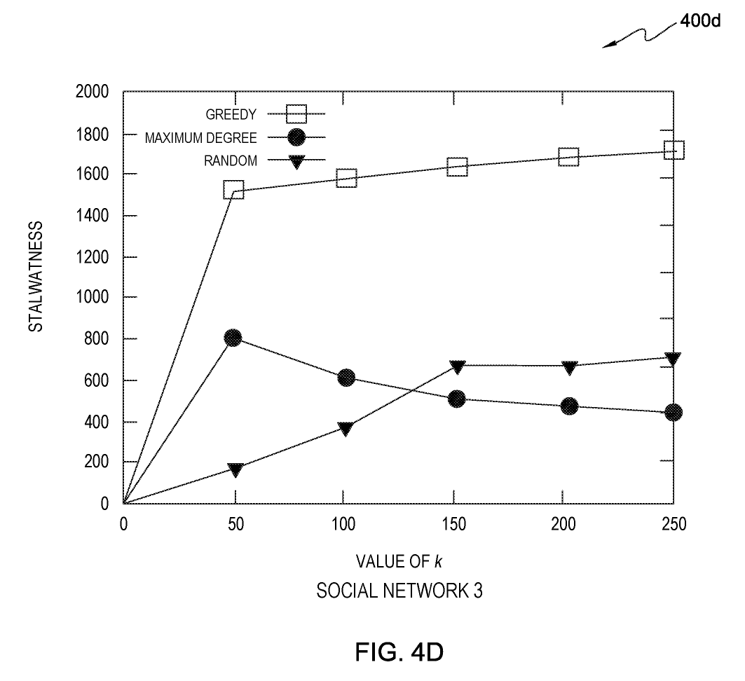

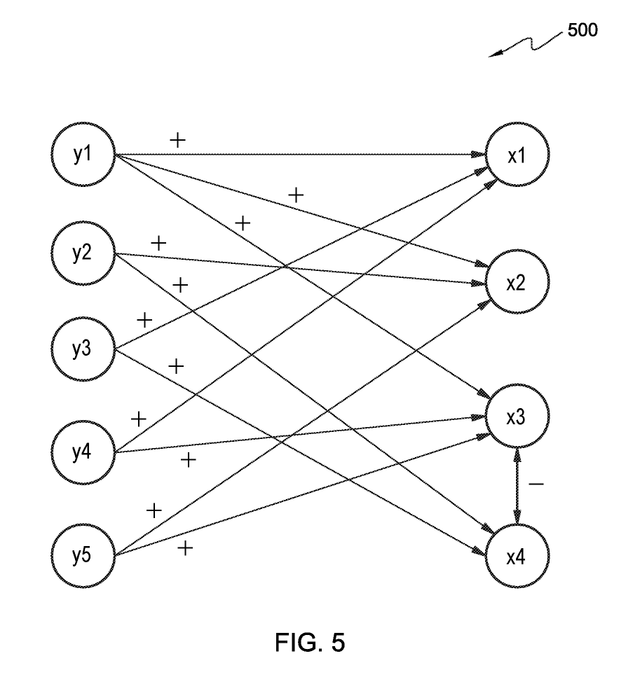

As shown in FIG. 4A, the contents of table 400a describe a snapshot of actual data from three signed social networks. For each of these signed social networks, table 400a describes the number nodes in the network, the number of edges in the network, and the respective fractions of positive and negative edges among these edges. The Greedy algorithm described above was tested using each of the three real life social networks represented in table 400a. The test results are presented in graphs 400b, 400c, and 400d, respectively of FIGS. 4B, 4C, and 4D.

Graphs 400b, 400c and 400d respectively correspond to SOCIAL NETWORKS 1, 2, and 3, of table 400a. In the graphs (400b, 400c, and 400d), the horizontal axis (X-axis) refers to the value of k and the vertical axis (Y-axis) refers to the value of stalwartness. For any given value of k, the graph shows the stalwartness value of the set of k nodes selected by the above described Greedy algorithm in comparison with that of two heuristics: (i) Maximum Degree heuristic, and (ii) Random heuristic. In this embodiment, the solution identified by Greedy is superior (yields higher stalwartness values) to solutions from maximum degree and random heuristics.

Some embodiments of the present invention may include one, or more, of the following features, characteristics and/or advantages: (i) able to suggest which nodes, of a set of signed social networks that capture real-life social interactions to target for the purpose of spreading information over a network; (ii) is useful in statistical analysis programs in fields including social science, market research, health research, opinion surveys, education research, data mining, etc.; (iii) helps to recommend new contacts in an organizational setting, contacts that are socially well-connected and/or well trusted (useful in the context of intercompany relationships and partnerships; and/or (iv) useful in designing or improving city infrastructure by, for example, helping to identify areas of travel congestion and therefore providing input in helping to identify solutions.

Lemma: The top-k stalwart nodes problem is NP-hard. Proof is presented in the following few paragraphs.

Consider an arbitrary instance of the NP-complete Hitting Set problem, defined by a collection C={S₁, S₂, . . . , Sₘ} where each SᵢεC is a subset of the ground set U={1, 2, . . . , n}. Determine whether there exists S*⊂U and an integer k such that |S*|=k and S*∩Sᵢ≠ for each SᵢεC (assume that k<n<m).

Given any arbitrary instance of the Hitting Set problem, construct a directed graph G′ with positive and negative links as follows:

Introduce a node xᵢ in G′ corresponding to each element iεU and a node yⱼ in G′ corresponding to each element SⱼεC. This results in a total of n+m nodes in G′.

Create directed edges in G′ as follows: Introduce a directed edge (yⱼ,xᵢ) with positive sign whenever iεSⱼ. Introduce negative signed directed edges (xᵢ_{₁},xᵢ_{₂}) and (xᵢ_{₂},xᵢ_{₁}) for each pair of elements i₁,i₂εU whenever there is no SⱼεC such that i₁εSⱼ and i₂εSⱼ. This results in a total of |S₁|+|S₂|+ . . . +|Sₘ| positive edges and n(n−1)−Σ_{S}_{ᵢ}_{εC}|Sᵢ∥S₁−1| negative edges in G′.

Directed graph 500 of FIG. 5 presents a stylized example of constructing G′ from the following instance of the Hitting Set problem: U={1, 2, 3, 4}, S₁={1, 2, 3}, S₂={2, 4}, S₃={1, 4}, S₄={1, 3}, S₅={2, 3}, and k=2.

The Hitting Set problem is equivalent to deciding if there is a set I of size k such that σ₂(I)≧m−n+k. Using a solution to the Hitting Set problem, construct I with all vertices corresponding to the elements in the solution of the Hitting Set problem. Note that |N⁺(I)|=m since the nodes in I correspond to a solution of the Hitting Set problem.

Note that |N⁻(I)|≦n−k since the k vertices corresponding to the elements in the solution of Hitting Set problem can have negative links from at most (n−k) nodes. Now it is clear that σ₂(I)=|N⁺(I)|−|N⁻(I)|≧m−(n−k).

On the other hand, if we have a set I with k nodes such that σ₂(I)≧m−(n−k), then the Hitting Set problem is solvable as the sets corresponding to the nodes in I form a solution to the set cover problem.

Lemma: The greedy algorithm approximates the stalwartness of any set of size k to within a ratio of (1−e^{-H}^{ₖ}) where Hₖ is the k^{th} harmonic number. Proof is presented in the following few paragraphs.

Let I* be the optimal set of size k with maximum spread and σ₁(I*) be the value of its spread. Let Iᵢ be the set of all nodes chosen by the end of i^{th} iteration of the greedy algorithm and Xᵢ be the contribution of the i^{th} node towards maximizing the spread. That is, Xᵢ=σ₁(Iᵢ)−σ₁(Iᵢ₋₁). (Note that I₀=). First, consider X₁ and the following holds:

$${X}_{1} \geq \frac{{σ}_{1} ( {I}^{*} )}{k} {σ}_{1} ( {I}^{*} ) - {X}_{1} \leq {σ}_{1} ( {I}^{*} ) ( 1 - \frac{1}{k} )$$

Next, consider X₂ and the following holds:

$${X}_{2} \geq \frac{{σ}_{1} ( {I}^{*} ) - {X}_{1}}{k - 1} {σ}_{1} ( {I}^{*} ) - {X}_{1} - {X}_{2} \leq {σ}_{1} ( {I}^{*} ) ( 1 - \frac{1}{k} ) ( 1 - \frac{1}{k - 1} )$$

Proceeding along similar lines, we get

$${σ}_{1} ( {I}^{*} ) - {\sum }_{i = 1}^{i = k} {X}_{i} \leq ( {I}^{*} ) {\prod }_{i = 1}^{i = k} ( 1 - \frac{1}{k - i + 1} ) \frac{{\sum }_{i - 1}^{i = k} {X}_{i}}{{σ}_{1} ( {I}^{*} )} \geq 1 - {\prod }_{i = 1}^{i = k} ( 1 - \frac{1}{k - i + 1} ) \geq 1 - {e}^{- \frac{1}{k}} {e}^{- \frac{1}{k - 1}} … {e}^{- 1} = 1 - {e}^{- {H}_{k}} .$$

This completes the proof.

Some embodiments of the present invention may include one, or more, of the following features, characteristics and/or advantages: (i) considers that a given social network consists of both positive and negative edges; (ii) carries out both amplification and attenuation by the stalwart nodes; (iii) computes the top-K stalwart nodes in a given signed social network by analyzing the underlying link structure (by deterministically measuring the external impact of the stalwart nodes based on incoming positive and negative links from outside nodes) among the nodes without the need to run any stochastic process on the network; (iv) formulates an underlying objective function (stalwartness) in a Greedy algorithm paradigm that is very different, in both definition and context; (v) considers the internal connectivity pattern (the difference between the number of positive and negative edges) among the Stalwart nodes along with their external connectivity pattern (the difference between the number of positive and negative edges from the external nodes).

Some embodiments of the present invention consider a scenario where each edge has a weight W which takes on a value in the range of −1 to +1. For instance, if W=+0.8, then it indicates a strong friendship between the two corresponding individuals. In contrast, if W=−0.9, then the two corresponding individuals are foes.

In another embodiment, if two influential nodes are connected to a third node where W of the first influential node is +0.8 and W of the second influential node is 0.6, then the third node is more strongly influenced by the first node than by the second node. In some embodiments of the present invention, these weights are considered appropriately in defining the objective function. A greedy algorithm can also handle this generalized model as well.

Some embodiments of the present invention may include one, or more, of the following features, characteristics and/or advantages: (i) defines “influential nodes” in social networks in combination with an objective/task; (ii) defines and/or finds “influential nodes” in social networks for the objective of maximizing the stalwartness in signed social networks; and/or (iii) assumes a social network has positive/negative signs associated with connections between nodes.

In some embodiments of the present invention, a method is used to determine stalwart nodes in signed social networks using a combination of the following operations: (i) define stalwartness of a set of nodes as the difference between the number of positive connections from the other nodes and the number of negative connections from the other nodes; (ii) determine the top-k stalwart nodes in a given signed social network; and/or (iii) analytically quantify the quality of the top-k stalwart nodes determined in item (ii) above.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

Aggregate assignation value: any way of meaningfully combining the signage values of connections involving a node, or sub-set of nodes (considered collectively), of a social network graph data set; for example, a given subset of nodes' aggregate assignation values may, or may not, be normalized against the number of connections involving that subset of nodes' connections.

NP-hard (nondeterministic polynomial time) problem: a computational problem is NP-hard if an algorithm for solving the NP-hard problem can be translated into an algorithm for solving any NP-problem; in other words, NP-hard means “at least as hard as any NP-problem.”

Greedy algorithm: an algorithm that follows the problem solving method of making a locally optimal choice at each stage, with the objective of finding an optimum, or at least good, global solution.

### Symbol Definitions:

| Symbol | Name | Example | Meaning |
|---|---|---|---|
| ∈ | Membership | A ∈ [B] | Element A is a member of set B |
| ⊂ | Subset | [A] ⊂ [B] | All elements of set A are also elements of set B. |
| ⊂ | Proper subset | [A] ⊂ [B] | All elements of set A are also elements of set B and set A is not equivalent to set B. |
| ∩ | Intersection | [A] ∩ [B] [symbol] [C] | Each element of set C is a member of both sets A and B. |
| ${\sum }_{i = 1}^{i = n} ( {x}_{i} )$ | Summation | x₁ + x₂ + . . . + xₙ | Sum of all terms in the expression |
| ${\prod }_{i = 1}^{i = n} ( {y}_{i} )$ | Product | y₁ × y₂ × . . . × yₙ | Product of all terms in the expression |
| σ(I) | Stalwartness (of set I) | | See sub-section Further Comments and/or Embodiments of this Detailed Description. |
| Ø | Null set | | An empty set. |
| k^{th} harmonic number | | $1 + \frac{1}{2} + \frac{1}{3} + … + \frac{1}{n}$ | ${\sum }_{k = 1}^{k = n} \frac{1}{k}$ (Sum of the reciprocals of the first n natural numbers) |

What is claimed is:

1. A computer-implemented method comprising:
receiving a machine readable signed social network data set that includes data representing a plurality of nodes and a plurality of signed connections among and between the nodes, with each signed connection having an assignation value;
receiving a positive integer value k that is less than a number of total nodes in the plurality of nodes; and
identifying, by machine logic, a set of k most-stalwart node(s) of the plurality of nodes of the social network data set, where the most-stalwart nodes have the largest aggregate assignation values, with an aggregate assignation value for a given node is a numerical value quantifying an aggregate of assignation values of connections involving the given node, and k is a positive integer.

2. The computer-implemented method of claim 1 further comprising at least one of the following steps:
saving information indicative of an identity of the set of k most-stalwart nodes in machine readable form on a storage device of a particular machine; and/or
communicating indicative of the identity of the set of k most-stalwart nodes to a human user in human understandable form and format.

3. The computer-implemented method of claim 1 wherein the assignation values of the signed social network data set follow one of the following assignation schemes:
each connection has one of the following types of assignation values: positive (+), or negative (−); or
each connection has one of the following types of assignation values: positive (+), negative (−) or neutral (0).

4. The computer-implemented method of claim 1 wherein the identification of the set of k most-stalwart node(s) includes:
applying, by machine logic, a Greedy algorithm to the signed social network data set.

5. The computer-implemented method of claim 4 wherein the application of the Greedy algorithm to the signed social network data set determines the identification of the k most stalwart nodes accurately within a ratio of (1−e^{-H}^{ₖ}).

6. The computer-implemented method of claim 1 wherein the identification of the set of k most-stalwart node(s) includes:
dividing the plurality of nodes into a plurality of sub-sets of nodes;
determining an aggregate assignation value for each subset of the plurality of sub-sets of nodes;
selecting a plurality of selected sub-sets for further analysis based, at least in part, on aggregate assignation values of the sub-sets; and
performing further analysis only on the plurality of selected sub-sets to identify the top-k stalwart nodes of the plurality of nodes.

7. The computer-implemented method of claim 1 wherein the aggregate assignation value of a first set is determined as the difference between a number of elements in a second set T⁺(I) and the number of elements in a third set T⁻(I), where:
T⁺(I) is a set of positive connections involving the first set; and
T⁻(I) is a set of negative connections involving the first set.

8. The computer-implemented method of claim 1 wherein the aggregate assignation value of a first set is determined as the difference between the number of elements in a second set T⁺(I) and the number of elements in a third set T⁻(I) plus the difference between the number of elements in a fourth set L⁺(I) and the number of elements in a fifth set L⁻(I), where:
T⁺(I) is a set of positive connections involving the first set;
T⁻(I) is a set of negative connections involving the first set;
L⁺(I) is a set of positive connections involving the nodes in I; and
L⁻(I) is a set of negative connections involving any node in I.

9. The computer-implemented method of claim 1 wherein the aggregate assignation value of a first set is determined as the difference between the number of elements in a second set W⁺(I) and the number of elements in a third set W⁻(I), where:
W⁺(I) is a summation of weights, each weight applied to each respective edge in I, involving positive incoming links to any node in I; and
W⁻(I) is a summation of weights, each weight applied to each respective edge in I, involving negative links to any node in I.

10. A computer-implemented method comprising:
receiving a machine readable signed social network data set that includes data representing a plurality of nodes and a plurality of signed connections among and between the nodes, with each signed connection having an assignation value;
receiving an integer value k; and
identifying, by machine logic, a set of k least-stalwart node(s) of the plurality of nodes of the social network data set, where the most-stalwart nodes have the lowest aggregate assignation values, with an aggregate assignation value for a given node is a numerical value quantifying an aggregate of assignation values of connections involving the given node.

11. The computer-implemented method of claim 10 further comprising at least one of the following steps:
saving information indicative of an identity of the set of k least-stalwart nodes in machine readable form on a storage device of a particular machine; and/or
communicating indicative of the identity of the set of k least-stalwart nodes to a human user in human understandable form and format.

12. The computer-implemented method of claim 10 wherein the assignation values of the signed social network data set follow one of the following assignation schemes:
each connection has one of the following types of assignation values: positive (+), or negative (−); or
each connection has one of the following types of assignation values: positive (+), negative (−) or neutral (0).

13. A computer program product comprising a computer readable storage medium having stored thereon:
first program instructions programmed to receive a machine readable signed social network data set that includes data representing a plurality of nodes and a plurality of signed connections among and between the nodes, with each signed connection having an assignation value;
second program instructions programmed to receive a positive integer value k that is less than a number of total nodes in the plurality of nodes; and
third program instructions programmed to identify, by machine logic, a set of k most-stalwart node(s) of the plurality of nodes of the social network data set, where the most-stalwart nodes have the largest aggregate assignation values, with an aggregate assignation value for a given node is a numerical value quantifying an aggregate of assignation values of connections involving the given node, and k is a positive integer.

14. The computer program product of claim 13 further comprising at least one of the following steps:
fourth program instructions programmed to save information indicative of the identity of the set of k most-stalwart nodes in machine readable form on a storage device of a particular machine; and/or
fifth program instructions programmed to communicate indicative of the identity of the set of k most-stalwart nodes to a human user in human understandable form and format.

15. The computer program product of claim 13 wherein the assignation values of the signed social network data set follow one of the following assignation schemes:
each connection has one of the following types of assignation values: positive (+), or negative (−); or
each connection has one of the following types of assignation values: positive (+), negative (−) or neutral (0).

16. The computer program product of claim 13 wherein the identification of the set of k most-stalwart node(s) includes:
applying, by machine logic, a Greedy algorithm to the signed social network data set.

17. The computer program product of claim 16 wherein the application of the Greedy algorithm to the signed social network data set determines the identification of the k most stalwart nodes accurately within a ratio of (1−e^{-H}^{ₖ}).

18. The computer program product of claim 13 wherein the identification of the set of k most-stalwart node(s) includes:
fourth program instructions programmed to divide the plurality of nodes into a plurality of sub-sets of nodes;
fifth program instructions programmed to determine an aggregate assignation value for each subset of the plurality of sub-sets of nodes;
sixth program instructions programmed to select a plurality of selected sub-sets for further analysis based, at least in part, on aggregate assignation values of the sub-sets; and
seventh program instructions programmed to perform further analysis only on the plurality of selected sub-sets to identify the top-k stalwart nodes of the plurality of nodes.

19. The computer program product of claim 13 further comprising:
a processor(s) set;
wherein:
the computer program product is a computer system, and
the processor(s) set is structured, located, connected and/or programmed to run the program instructions stored on the computer readable storage medium.

20. The computer program product of claim 19 wherein the identification of the set of k most-stalwart node(s) includes:
fourth program instructions programmed to divide the plurality of nodes into a plurality of sub-sets of nodes;
fifth program instructions programmed to determine an aggregate assignation value for each subset of the plurality of sub-sets of nodes;
sixth program instructions programmed to select a plurality of selected sub-sets for further analysis based, at least in part, on aggregate assignation values of the sub-sets; and
seventh program instructions programmed to perform further analysis only on the plurality of selected sub-sets to identify the top-k stalwart nodes of the plurality of nodes.
